(19) United States
(12) Patent Application Publication
(10) Pub. No.: US 2024/0218155 A1
(43) Pub. Date: Jul. 4, 2024

(54) ANTISTATIC COMPOSITION AND OLEFIN POLYMERIZATION METHOD

(71) Applicant: ZJU-HANGZHOU GLOBAL SCIENTIFIC AND TECHNOLOGICAL INNOVATION CENTER, Hangzhou (CN)

(72) Inventors: Yao YANG, Hangzhou (CN); Shiyi GE, Hangzhou (CN); Tinghao JIA, Hangzhou (CN); Jingdai WANG, Hangzhou (CN); Yongrong YANG, Hangzhou (CN); Zhengliang HUANG, Hangzhou (CN)

(21) Appl. No.: 18/239,132

(22) Filed: Aug. 29, 2023

Related U.S. Application Data
(63) Continuation of application No. PCT/CN2023/077627, filed on Feb. 22, 2023.

(30) Foreign Application Priority Data
Dec. 28, 2022 (CN) 202211695070.4

(51) Int. Cl. C08K 5/17; C08F 4/00; C08F 10/00; C08K 5/42

(52) U.S. Cl. CPC C08K 5/175; C08F 4/00; C08F 10/00; C08K 5/42

(57) ABSTRACT

An antistatic composition and an olefin polymerization method are provided. The antistatic composition includes: an oil-soluble hyperbranched polyamidoamine, an oil-soluble surfactant and an aliphatic hydrocarbon, wherein the oil-soluble hyperbranched polyamidoamine has a molecular weight with a range of 5000 to 40000. The olefin polymerization method includes: adding an olefin, a catalyst and the antistatic composition into a polymerization reactor to undergo a polymerization to obtain a polyolefin.

### CROSS-REFERENCES TO RELATED APPLICATIONS

The present disclosure is a continuation of international patent application No. PCT/CN2023/077627, filed on Feb. 22, 2023, which itself claims priority to Chinese Patent Application No. 202211695070.4, entitled “ANTISTATIC COMPOSITION AND OLEFIN POLYMERIZATION METHOD”, filed on Dec. 28, 2022, which are hereby incorporated by reference in its entirety.

### TECHNICAL FIELD

The present disclosure relates to the technical field of olefin polymerization, in particular, to an antistatic composition and an olefin polymerization method.

### BACKGROUND

In an industrial production of polyolefin, high insulation of polyolefin particles and a dry and water-free reaction environment in a polymerization reactor cause accumulation of static electricity generated during a polymerization. When the static electricity is excessive, it is very easy to cause catalysts and polyolefin particles to adhere to and melt on the wall of the polymerization reactor, forming sheets and fouling. When the sheets and fouling fall off and enter a reaction zone, it will seriously interfere with the production flow in the polymerization reactor and block a product outlet, eventually forcing the polymerization reactor to stop production.

In order to control the problems of flaking and agglomeration caused by static electricity, the methods in the prior art mainly reduce the generation of static electricity by adding antistatic substances to the polymerization reactor. For instance, some technologies use alkyldiethanolamines as antistatic substances, some technologies use straight-chain ethylene oxide-propylene oxide copolymers as antistatic substances, other technologies use fatty acid esters, metal carboxylates or alkyl ammonium salts as the main active ingredients of antistatic compositions. However, these antistatic substances have antistatic properties based on the principle that hydrophilic groups capture environmental moisture and reduce the resistivity of polyolefin surface, thus accelerating the dissipation of electrostatic charge. Therefore, the antistatic effect of these antistatic substances encounters challenges in the extreme water-free environment of the polymerization reactor where a high addition of these antistatic substances is required to effectively restrain static electricity. In addition, these antistatic substances will react or complex with catalysts, resulting in a decline in the activity of the catalysts. Moreover, the higher the addition of antistatic substances, the more obvious the decline in the activity of the catalysts.

### SUMMARY

According to various embodiments of the present disclosure, an antistatic composition and an olefin polymerization method are provided. According to the method, an antistatic composition is used during olefin polymerization, which keeps a water-free polymerization reactor running at a low electrostatic level, and also less affects the activity of the catalyst.

The present disclosure provides an antistatic composition for olefin polymerization. The antistatic composition includes: an oil-soluble hyperbranched polyamidoamine, an oil-soluble surfactant and an aliphatic hydrocarbon, wherein the oil-soluble hyperbranched polyamidoamine has a molecular weight with a range of 5000 to 40000.

In an embodiment, the antistatic composition includes, in percentage by mass, 0.1%-10% of the oil-soluble hyperbranched polyamidoamine, 5%-30% of the oil-soluble surfactant, and 60%-94% of the aliphatic hydrocarbon.

In an embodiment, the oil-soluble hyperbranched polyamidoamine is selected from hyperbranched polyamidoamines of a structural formula (1),

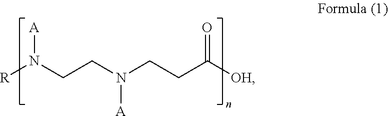

Formular (1)
   in formula (1), A is H or a branched unit, and R is H or an alkyl chain.

In an embodiment, the alkyl chain has a grafting rate of 5%-45%.

In an embodiment, the alkyl chain is C₁₀-C₁₀₀ normal alkyl chains, —C₁₀₀ isomeric alkyl chains, or any combination thereof.

In an embodiment, the oil-soluble surfactant is an alkylsulfonic acid, an alkylamine, an alkylaminesulfonic acid, or any combination thereof.

In an embodiment, C₅-C₂₀ normal paraffins, C₅-C₂₀ isoparaffins, C₅-C₂₀ cycloparaffins, or any combination thereof.

Further provided is an olefin polymerization method, including: adding an olefin, a catalyst and the antistatic composition into a polymerization reactor to undergo a polymerization to obtain a polyolefin.

In an embodiment, based on a weight of the polyolefin in the polymerization reactor, a weight of the antistatic composition is 2 ppm-200 ppm of that of the polyolefin.

In an embodiment, the catalyst is a metallocene catalyst, a Ziegler-Natta catalyst, a chromium based catalyst, or any combination thereof.

### DETAILED DESCRIPTION OF THE EMBODIMENTS

The technical solutions in the embodiments of the present disclosure will be described clearly and completely below in connection with the drawings in the embodiments of the present disclosure, and it will be apparent that the embodiments described herein are merely some, not all of the embodiments of the present disclosure. All other embodiments obtained by a person of ordinary skill in the art based on the embodiments of the present disclosure without creative efforts shall fall within the protection scope of the present disclosure.

Unless defined otherwise, all technical and scientific terms used herein have the same meanings as are commonly understood by those skilled in the art. The terms used herein in the description of the present disclosure are only for the purpose of describing specific implementations or embodiments but not intended to limit the present disclosure. The optional range of the term “and/or” used herein includes any one of two or more related items listed, and also includes any and all combinations of relevant listed items. Such any and all combinations include combinations of any two of the relevant listed items, any more of the relevant listed items, or all of the relevant listed items.

The antistatic composition of the present disclosure is mainly used for olefin polymerization. The antistatic composition does not rely on the water absorption of the surfactant, and is suitable for a water-free polymerization reactor environment.

Specifically, the antistatic composition includes an oil-soluble hyperbranched polyamidoamine, an oil-soluble surfactant and an aliphatic hydrocarbon. The oil-soluble hyperbranched polyamidoamine can be adsorbed on surfaces of polyolefin particles and induce positive charges on surfaces of polyolefin particles through amine groups to neutralize and eliminate negative static electricity caused by friction between the polyolefin particles and a surface of a sidewall of a polymerization reactor, and the oil-soluble surfactant can fine-tune the positive initiation behavior of the hyperbranched polyamidoamine. Under the synergistic action of the hyperbranched polyamidoamine and the oil-soluble surfactant, the water-free polymerization reactor can be kept running at a low electrostatic level.

Specifically, the oil-soluble hyperbranched polyamidoamine of the present disclosure has a molecular weight within a range of 5000 to 40000, and in this molecular weight range, the molecular spatial structure of the hyperbranched polyamidoamine has a size within a range of 5 nm to 30 nm, and hyperbranched polyamidoamine molecules within this size range cannot enter micropores of the catalyst, thus less affecting the activity of the catalyst.

In order to improve the static elimination and neutralization effect of the antistatic composition in the process of olefin polymerization, in an embodiment, the hyperbranched polyamidoamine is selected from hyperbranched polyamidoamines of structural formula (1),

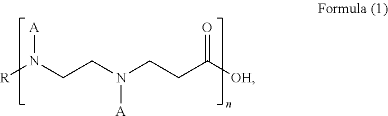

wherein in formula (1), A is H or A is a branched unit, and R is H or an alkyl chain.

In order to improve the oil solubility of the hyperbranched polyamidoamine of formula (1), the alkyl chain has a grafting rate of 5% to 45%, such as 5%, 10%, 15%, 20%, 25%, 30%, 35%, 40%, 45%, etc. The alkyl chain is C₁₀-C₁₀₀ normal alkyl chains, C₁₀-C₁₀₀ isomeric alkyl chains, or any combination thereof, such as C₁₀ normal alkyl chains or isomeric alkyl chains, C₂₀ normal alkyl chains or isomeric alkyl chains, C₄₀ normal alkyl chains or isomeric alkyl chains, C₆₀ normal alkyl chains or isomeric alkyl chains, C₈₀ normal alkyl chains and isomeric alkyl chains, and C₁₀₀ normal alkyl chains and isomeric alkyl chains.

Optionally, the oil-soluble hyperbranched polyamidoamine has a structural formula (2), where R₁ is a C₂₀ alkyl chain, a molecular weight is 280, and the grafting a grafting rate is 10%. A molecular weight of the entire hyperbranched polyamidoamine is 12500.

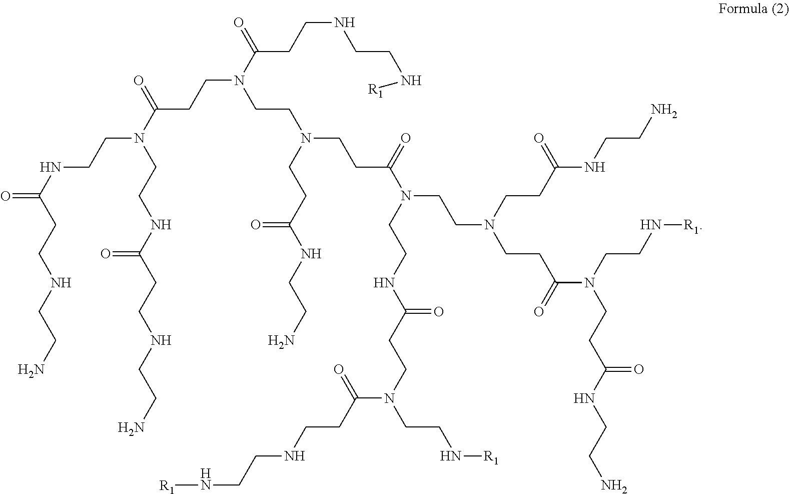

In order to better fine-tune the positive initiation behavior of the hyperbranched polyamidoamine, in an embodiment, the oil-soluble surfactant is an alkylsulfonic acid, an alkylamine, an alkylaminesulfonic acid, or any combination thereof. The alkylsulfonic acid is dodecylbenzenesulfonic acid, dinonylnaphthylsulfonic acid, or any combination thereof. The alkylamine is lauryl dimethyl tertiary amine, lauryl trimethyl ammonium chloride, tris(trimethylsilyl) amine, or any combination thereof. The alkylaminesulfonic acid is lauryl dimethyl sulfobetaine, tetradecyl sulfobetaine, or any combination thereof.

As a suitable solvent, in an embodiment, the aliphatic hydrocarbon is C₅-C₂₀ normal paraffins, C₅-C₂₀ isoparaffins, C₅-C₂₀ cycloparaffins, or any combination thereof, such as isopentane, n-hexane, cyclohexane, n-heptane, and n-octane.

The antistatic composition of the present disclosure includes, in percentage by mass, 0.1%-10% of the oil-soluble hyperbranched polyamidoamine, 5%-30% of the oil-soluble surfactant, and 60%-94% of the aliphatic hydrocarbon. Specifically, by monitoring the electrostatic level of the polymerization reactor, the amount of the antistatic composition introduced into the polymerization reactor may be adjusted according to the electrostatic level.

Optionally, in a case of a higher percentage, by mass, of the hyperbranched polyamidoamine in the antistatic composition, the requirement for oil solubility is higher. And its oil solubility may be improved by further increasing the length of its alkyl chain and the grafting ratio.

The present disclosure further provides an olefin polymerization method, including: adding an olefin, a catalyst and the antistatic composition described above into a polymerization reactor to undergo a polymerization to obtain a polyolefin.

In order to further keep the static electricity in the polymerization reactor at a lower level, based on a weight of the polyolefin in the polymerization reactor, a weight of the antistatic composition is 2 ppm-200 ppm of that of the polyolefin.

Since the antistatic composition of the present disclosure is free of water and has an extremely low hydroxyl content, in an embodiment, the catalyst may be a metallocene catalyst, a Ziegler-Natta catalyst, a chromium based catalyst, or any combination thereof.

The antistatic composition and the olefin polymerization method will be further described below by way of the following specific examples.

### I. Static Elimination Experiment

The electrostatic behavior of polyolefin particles in a polymerization reactor is simulated by using a cold mold fluidized bed device which is configured as a stainless steel cylinder with a diameter of 80 mm, a height of 800 mm, and a static bed height of 240 mm.

400 g of polyethylene particles from the production of an industrial fluidized bed polymerization reactor is added to ensure that the electrostatic behavior of the polyethylene particles comply with the industry. The polyethylene particles are fluidized for 1 h with pure nitrogen at a gas velocity of 0.35 m/s until the polyethylene particles are stably charged. Then, different weights of antistatic composition are added above a distribution plate. The polyethylene particles are further fluidized for 10 min and then sampled near the distribution plate and near a material level. The charge-to-mass ratio is measured 5 times by a Faraday cylinder method, and the average value was calculated. The results are shown in Table 1.

### Example 1

The above-mentioned cold mold fluidized bed device and method were used in this example. The antistatic composition in this example included, in percentage by mass, 1% of a hyperbranched polyamidoamine of structural formula (2), 5% of dodecylbenzenesulfonic acid and 94% n-heptane.

### Example 2

The above-mentioned cold mold fluidized bed device and method were used in this example. The antistatic composition in this example included, in percentage by mass, 0.1% of a hyperbranched polyamidoamine of structural formula (2), 10% of tris(trimethylsilyl)amine and 89.9% of n-hexane.

### Example 3

The above-mentioned cold mold fluidized bed device and method were used in this example. The antistatic composition in this example included, in percentage by mass, 10% of a hyperbranched polyamidoamine, 20% of dinonylnaphthylsulfonic acid, 8% of lauryl dimethyl tertiary amine, 2% of lauryl dimethyl sulfobetaine, and 60% n-hexane.

The structural formula of the hyperbranched polyamidoamine used was consistent with formula (2), but R₁ was a C₂₅ alkyl chain, its grafting rate was 35%, and the molecular weight of the entire hyperbranched polyamidoamine was 17800.

### Comparative Example 1

The above-mentioned cold mold fluidized bed device and method were used in this comparative example. The antistatic composition in this comparative example included 10% of alkyldiethanolamine and 90% of n-heptane.

### Comparative Example 2

The above-mentioned cold mold fluidized bed device and method were used in this comparative example. The antistatic composition in this comparative example included 10% of dodecylbenzenesulfonic acid and 90% of n-heptane.

### Comparative Example 3

The above-mentioned cold mold fluidized bed device and method were used in this comparative example. The antistatic composition in this comparative example included 1% of a hyperbranched polyamidoamine of structural formula (2) and 99% of n-heptane.

TABLE 1

| | Charge-to-mass ratio of particles (μC/kg) | | | | | |
|---|---|---|---|---|---|---|
| Addition | | | | Comparative | Comparative | Comparative |
| (ppm in weight) | Example 1 | Example 2 | Example 3 | Example 1 | Example 2 | Example 3 |
| 0 | −11.7 | −11.5 | −11.4 | −11.5 | −11.8 | −11.3 |
| 5 | −9.7 | −10.2 | −7.2 | −11.2 | −12.6 | −8.6 |
| 10 | −6.3 | −8.9 | −4.1 | −10.9 | −12.9 | −5.8 |
| 25 | −2.5 | −6.2 | −0.8 | −9.4 | −12.3 | −1.6 |
| 50 | −0.9 | −3.9 | −0.1 | −8.5 | −11.4 | 1.5 |
| 100 | −0.2 | −1.5 | −0.1 | −6.7 | −10.9 | 2.6 |
| 200 | 0.4 | −0.4 | 0.1 | −1.6 | −8.9 | 3.8 |
| 400 | 0.8 | 0.5 | 0.2 | 0.3 | −1.4 | 5.8 |
| 800 | 1.3 | 2.1 | 0.2 | 0.5 | −0.8 | 6.1 |

Referring to Table 1, in Comparative Example 1 and Comparative Example 2, conventional surfactants are used as the main antistatic active substances. They have poor static elimination effects in water-free environments, and they need to be added in amounts of 200 ppm and 400 ppm in weight respectively to control static electricity at a low level. The alkyldiethanolamine used in Comparative Example 1 contains amine groups, so the final static elimination effect is positive, while the dodecylbenzenesulfonic acid used in Comparative Example 2 contains sulfonic groups, so the final static elimination effect is negative. Comparative Example 3 uses hyperbranched polyamidoamine as the main antistatic active substance, which has a high ratio of amine groups and is very easy to induce positive charges on the surface of polyolefin particles. The addition of 25 ppm in weight can basically neutralize and eliminate negative static electricity. However, if the antistatic composition is added in excess, that is, in an amount of more than 50 ppm in weight, the electrostatic polarity of the particles will reverse and increase sharply, making it difficult to maintain a stable low static state during operation. In the antistatic composition used in Example 1, the hyperbranched polyamidoamine is compounded with dodecylbenzenesulfonic acid (i.e., the oil-soluble surfactant). Under the interaction of the hyperbranched polyamidoamine and dodecylbenzenesulfonic acid, the static electricity in the water-free polymerization reactor can be kept at a low level efficiently. In Example 2, a relatively low concentration of hyperbranched polyamidoamine and tris(trimethylsilyl)amine is used, which can slowly eliminate negative static electricity. This formulation has a high operation error tolerance rate during the process of controlling the static electricity of the polymerization reactor. In Example 3, a relatively high concentration of hyperbranched polyamidoamine is used and compounded with alkylsulfonic acid, alkylamine and alkylaminesulfonic acid, which can eliminate negative static electricity more efficiently and keep static electricity at a low level.

### II. Olefin Polymerization Experiment

### Comparative Example 1

In a 2 L glass reactor, a metallocene catalyst was used to carry out ethylene polymerization, and the specific operation was as follows.

The glass reactor was placed in an oven, and heated and dried at 105° C. for 2 h to ensure that the glass reactor was a water-free reaction environment. Then, the glass reactor was heated to 80° C. in an oil bath, and then the glass reactor was evacuated and filled with high-purity nitrogen for gas replacement. This process was repeated three times, and the high-purity nitrogen was then replaced with ethylene gas, and the above operation was repeated three times.

86.4 g of a catalyst promoter methylaluminoxane (20 wt % toluene solution) was placed in the glass reactor, and then commercial metallocene catalyst bis (1-butyl-3-methyl cyclopentadienyl) zirconium dichloride was dissolved in 260 mL of toluene, and the resulting solution was poured into the glass reactor and stirred for 1 min. The ethylene pressure was then increased to 0.5 MPa to carry out the polymerization for 1 h, and acidified ethanol was slowly added to the product to stop the reaction. The resulting solution was filtered by suction, and the product was vacuum-dried at 60° ° C. for 24 h.

### Example 1

Example 1 is different from Comparative Example 1 only in that an antistatic composition in an amount of 25 ppm in weight of the polyethylene particles, based on the weight of the polyethylene particles in the glass reactor, was mixed into the metallocene catalyst. The antistatic composition included, in percentage by mass, 1% of a hyperbranched polyamidoamine of structural formula (2), 5% of dodecylbenzenesulfonic acid and 94% of n-heptane.

### Example 2

Example 2 is different from Comparative Example 1 only in that an antistatic composition in an amount of 25 ppm in weight of the polyethylene particles, based on the weight of the polyethylene particles in the glass reactor, was mixed into the metallocene catalyst. The antistatic composition included, in percentage by mass, 10% of a hyperbranched polyamidoamine, 20% of dinonylnaphthylsulfonic acid, 8% of lauryl dimethyl tertiary amine, 2% of lauryl dimethyl sulfobetaine and 60% of n-hexane. The structural formula of the hyperbranched polyamidoamine used was consistent with formula (2), but R₁ was a C₂₅ alkyl chain, its grafting rate was 35%, and the molecular weight of the entire hyperbranched polyamidoamine was 17800.

The test results of catalyst activity in Example 1, Example 2 and Comparative Example 1 are shown in Table 2.

TABLE 2

| | Comparative | | |
|---|---|---|---|
| | Example 1 | Example 1 | Example 2 |
| Catalyst activity (g | 8300 | 8180 | 8090 |
| PE/g Cat-hr) | | | |

Referring to Table 2, the catalyst activity in Comparative Example 1 is 8300 g PE(gCat-hr)⁻¹, the catalyst activity in Example 1 is 8180 g PE(gCat-hr), and the catalyst activity in Example 2 is 8160 g PE/(g Cat-hr). It can be seen that the addition of the antistatic composition slightly affects catalyst activity and only reduces the catalyst activity by 1.4% and 2.5%, respectively.

### Comparative Example 2

In a 1.1 L stainless steel autoclave reactor, a Ziegler-Natta catalyst was used for ethylene polymerization, and the specific operations were as follows:

The stainless steel autoclave reactor was evacuated and heated to 95° C. and held at this temperature for 3 h. Then, the stainless steel autoclave reactor was cooled to 75° C. through constant-temperature circulating water in a jacket, and 400 mL of n-heptane was added in the reactor. In a nitrogen atmosphere, a catalyst additive triethylaluminum was first added and the Ziegler-Natta catalyst was then added, and the stainless steel autoclave reactor was kept at a pressure of 0.8 MPa, and polymerization was carried out for 1 h with continuous addition of ethylene. The synthesized polyethylene particles were immediately washed with acidified ethanol and dried in vacuum at 60° ° C. for 24 h.

### Example 3

Example 3 is different from Comparative Example 2 only in that an antistatic composition in an amount of 25 ppm in weight of the polyethylene particles, based on the weight of the polyethylene particles in the stainless steel autoclave reactor, was mixed into the Ziegler-Natta catalyst. The antistatic composition included, in percentage by mass, 1% of a hyperbranched polyamidoamine of structural formula (2), 5% of dodecylbenzenesulfonic acid and 94% of n-heptane.

### Example 4

Example 4 is different from Comparative Example 2 only in that an antistatic composition in an amount of 25 ppm in weight of the polyethylene particles, based on the weight of the polyethylene particles in the stainless steel autoclave reactor, was mixed into the Ziegler-Natta catalyst. The antistatic composition in this example included, in percentage by mass, 0.1% of a hyperbranched polyamidoamine of structural formula (2), 10% of tris(trimethylsilyl)amine and 89.9% of n-hexane.

The test results of catalyst activity in Example 3, Example 4 and Comparative Example 2 are shown in Table 3.

TABLE 3

| | Comparative | | |
|---|---|---|---|
| | Example 2 | Example 3 | Example 4 |
| Catalyst activity (g | 1080 | 1050 | 1060 |
| PE/g Cat-hr) | | | |

Referring to Table 3, the catalyst activity in Comparative Example 2 is 1080 g PE(gCat-hr)⁻¹, the catalyst activity in Example 3 is 1050 g PE(gCat-hr), and the catalyst activity in Example 4 is 1060 g PE/(g Cat-hr). It can be seen that the addition of the antistatic composition slightly affects catalyst activity and only reduces the catalyst activity by 2.84% and 1.9%, respectively.

The technical features of the above-described embodiments may be arbitrarily combined. For the brevity of description, all possible combinations of the technical features in the above examples are not described. However, as long as there is no contradiction between the combinations of these technical features, all should be considered as falling within the scope of the description.

The above examples only describe several implementations of the present disclosure, and their description is specific and detailed, but cannot therefore be understood as limiting the patent scope of the present disclosure. It should be noted that those of ordinary skill in the art may further make variations and improvements without departing from the concept of the present disclosure, and these all fall within the scope of the present disclosure. Therefore, the scope of the present disclosure for patent shall be based on the appended claims.

What is claimed is:

1. An antistatic composition for olefin polymerization, comprising: an oil-soluble hyperbranched polyamidoamine, an oil-soluble surfactant and an aliphatic hydrocarbon, wherein the oil-soluble hyperbranched polyamidoamine has a molecular weight with a range of 5000 to 40000.

2. The antistatic composition of claim 1, comprising, in percentage by mass, 0.1%-10% of the oil-soluble hyperbranched polyamidoamine, 5%-30% of the oil-soluble surfactant, and 60%-94% of the aliphatic hydrocarbon.

3. The antistatic composition of claim 1, wherein the oil-soluble hyperbranched polyamidoamine is selected from hyperbranched polyamidoamines of a structural formula (1), 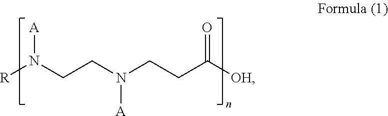
in formula (1), A is H or a branched unit, and R is H or an alkyl chain.

4. The antistatic composition of claim 3, wherein the alkyl chain has a grafting rate of 5% to 45%.

5. The antistatic composition of claim 3, wherein the alkyl chain is C₁₀-C₁₀₀ normal alkyl chains, C₁₀-C₁₀₀ isomeric alkyl chains, or any combination thereof.

6. The antistatic composition of claim 1, wherein the oil-soluble surfactant is an alkylsulfonic acid, an alkylamine, an alkylaminesulfonic acid, or any combination thereof.

7. The antistatic composition of claim 1, wherein the aliphatic hydrocarbon is C₅-C₂₀ normal paraffins, C₅-C₂₀ isoparaffins, C₅-C₂₀ cycloparaffins, or any combination thereof.

8. An olefin polymerization method, comprising: adding an olefin, a catalyst and an antistatic composition into a polymerization reactor to undergo a polymerization to obtain a polyolefin,
wherein the antistatic composition comprises: an oil-soluble hyperbranched polyamidoamine, an oil-soluble surfactant and an aliphatic hydrocarbon, wherein the oil-soluble hyperbranched polyamidoamine has a molecular weight with a range of 5000 to 40000.

9. The olefin polymerization method of claim 8, wherein based on a weight of the polyolefin in the polymerization reactor, a weight of the antistatic composition is 2 ppm-200 ppm of that of the polyolefin.

10. The olefin polymerization method of claim 8, wherein the catalyst is a metallocene catalyst, a Ziegler-Natta catalyst, a chromium based catalyst, or any combination thereof.
